(19) United States
(12) Patent Application Publication
(10) Pub. No.: US 2023/0280486 A1
(43) Pub. Date: Sep. 7, 2023

(54) RADIATION DETECTOR ARRAYS HAVING INCREASED EFFICIENCY AND METHODS OF OPERATING THEREOF

(71) Applicant: REDLEN TECHNOLOGIES, INC., Saanichton (CA)

(72) Inventors: Xavier DEFAY, Victoria (CA); Michael K. JACKSON, Victoria (CA); Krzysztof INIEWSKI, Port Moody (CA)

(21) Appl. No.: 18/170,290

(22) Filed: Feb. 16, 2023

Related U.S. Application Data
(60) Provisional application No. 63/316,588, filed on Mar. 4, 2022.

(51) Int. Cl. G01T 7/00; G01T 1/24

(52) U.S. Cl. CPC G01T 7/005; G01T 1/249; G01T 1/247

(57) ABSTRACT

Various embodiments include methods of compensating for signal loss due to depth-of-interaction (DOI) effects in radiation detectors, thereby improving detector efficiency. Various embodiments may include detecting the amplitude of a primary charge signal in a first pixel of an array of detector pixels in response to a photon interaction event, detecting the amplitude of a secondary charge signal in a second pixel of the array, where the amplitude of the secondary charge signal has an opposite polarity than the polarity of the primary charge signal, and generating a corrected photon energy measurement of the photon interaction event by applying a correction to the detected amplitude of the primary charge signal based on the detected amplitude of the secondary charge signal. Further embodiments include methods of improving detector efficiency by compensating for both depth-of-interaction (DOI) and charge sharing effects.

### FIELD

The present application relates generally to radiation detectors, and more specifically to radiation detectors having increased quantum efficiency (QE) and methods of operating thereof with depth-of-interaction effect correction.

### BACKGROUND

In Single Photon Emission Computed Tomography (SPECT) imaging systems, gamma rays emitted from a source, such as a radiopharmaceutical or radiotracer, are detected by a detector array, such as a cadmium zinc telluride (“CZT”) detector. Other direct conversion detectors employing cadmium telluride (CdTe), gallium arsenide (GaAs), or silicon (Si), or any indirect director based on a scintillator material, may also be used in SPECT imaging systems. Images taken at different angles are joined together to reconstruct 3-dimensional images of the object under examination.

The electrical signal generated by solid state radiation detectors, such as CZT detectors, results from gamma rays exciting electrons in the atoms of the detector material that ejects electrons from their orbits and into a conduction band of the bulk material. Each electron ejected into the conduction band leaves behind a net positive charge that behaves like a positively charged particle known as a “hole” that migrates through the material in response to an electric field applied between a cathode and an anode. Electrons in the conduction band are attracted by the resulting internal electric field and migrate to the anode where they are collected creating a small current that is detected by circuitry, while the holes migrate towards the cathode.

Each gamma-ray will generate many electron-hole pairs, depending on the energy of the photon. For example, the ionization energy of CZT is 4.64 eV, so absorbing the energy of a 140 keV gamma ray from technetium will generate about 30,000 electron-hole pairs.

An important parameter for solid-state ionizing radiation detector arrays, such as CZT detector arrays, is the Detector Quantum Efficiency (DQE), or in short, the “detector efficiency.” The detector efficiency represents the ratio of the number of photons properly registered (e.g., detected with the correct energy) with respect to number of photons emitted by the radiation source that impinge on the detector. The higher the efficiency, the shorter the scan needs to be (for the given photon source), and the smaller the radiation dose is, which is beneficial for the patient. This is particularly true in Nuclear Medicine applications, such as SPECT imaging, which are generally relatively higher radiation dose procedures (e.g., typically in a 1-12 mSv range), in which concerns about radiation damage are significant.

In an ideal detector array, the detector efficiency would be 100%. In practice, the measured efficiencies of detector arrays are less than 100%, and are typically in a range between 10% and 90%, depending on the particular detector array the and energy of interest. This may be due to a variety of factors, such as absorption losses, detector noise, as well as other effects.

### SUMMARY

Various embodiments are directed to a method for detecting ionizing radiation using a radiation detector having of an array of pixels, where the method includes detecting an amplitude of a primary charge signal in a first pixel of the array of pixels in response to a photon interaction event in the radiation detector, detecting an amplitude of a secondary charge signal in a second pixel of the array of pixels in response to the photon interaction event, wherein the amplitude of the secondary charge signal is less than the amplitude of the primary charge signal and a polarity of the secondary charge signal is opposite the polarity of the primary charge signal, and generating a corrected photon energy measurement of the photon interaction event by applying a correction to the detected amplitude of the primary charge signal based on the detected amplitude of the secondary charge signal.

Additional embodiments are directed to a method for detecting ionizing radiation using a radiation detector having of an array of pixels, where the method includes detecting an amplitude of a primary charge signal in a first pixel of the array of pixels in response to a photon interaction event in the radiation detector, detecting amplitudes of a plurality of secondary charge signals in a plurality of neighboring pixels of the first pixel, where a first set of one or more secondary charge signals has a polarity that is the same as the polarity of the primary charge signal, and a second set of one or more secondary charge signals has a polarity that is opposite the polarity of the primary charge signal, and generating a corrected photon energy measurement of the photon interaction event by adding the amplitude of each secondary charge signal of the first set of secondary charge signals to the amplitude of the primary charge signal, and subtracting the amplitude of each secondary charge signal of the second set of secondary charge signals from the amplitude of the primary charge signal.

Further embodiments are directed to an imaging radiation detector including an array of pixels, and detector processing circuitry coupled to each pixel and configured to detect the amplitude and polarity of charge signals within each pixel, the detector processing circuitry further configured to detect the amplitude of a primary charge signal in a first pixel of the array of pixels in response to a photon interaction event in the radiation detector, detect the amplitude of a secondary charge signal in a second pixel of the array of pixels in response to the photon interaction event, wherein the amplitude of the secondary charge signal is less than the amplitude of the primary charge signal and a polarity of the secondary charge signal is opposite the polarity of the primary charge signal, and generate a corrected photon energy measurement of the photon interaction event by applying a correction to the detected amplitude of the primary charge signal based on the detected amplitude of the secondary charge signal.

### BRIEF DESCRIPTION OF THE DRAWINGS

The accompanying drawings are presented to aid in the description of embodiments of the disclosure and are provided solely for illustration of the embodiments and not limitation thereof.

FIG. 1 is a block diagram of a Single Photon Emission Computed Tomography (SPECT) imaging system suitable for use with various embodiments of the present disclosure.

FIG. 2 is a conceptual cross section view diagram of a semiconductor pixel radiation detector illustrating gamma ray interactions.

FIG. 3A is a plot of Monte-Carlo simulations of the amplitudes of the signal induced on a pixel by a radiation source having a peak gamma emission energy of 356 keV versus the depth of interaction of photon interaction events.

FIG. 3B is plot of the Monte-Carlo simulations of FIG. 3A showing the total number of simulated photon energy measurements at different energies between 100 keV and 400 keV.

FIG. 4 is a plot of the weighting potential, w, versus the depth of interaction of photon interaction events for three different detectors.

FIG. 5 is a plot illustrating the weighting potential distributions of two pixelated detectors having different pixel pitches.

FIG. 6 shows plots of two-dimensional weighting potential distributions of a center detector pixel (right hand side) and a neighboring detector pixel (left hand side).

FIGS. 7A-7C are plots showing the charge signal evolution over time in the center pixel and the neighboring pixel in the simulation of FIG. 6 as electrons travel to the anode electrode over a 1 microsecond interval following photon interactions occurring at depths of 1 mm (FIG. 7A), 3 mm (FIG. 7B), and 5 mm (FIG. 7C) from the cathode.

FIGS. 8A-8C illustrate three different scenarios of photon interaction events occurring within a pixelated detector array.

FIG. 9 is a scatter plot of several hundred of simulated photon interaction events occurring in different locations (e.g., X, Y positions) in a radiation detector.

FIG. 10 is a plot of amplitudes of primary charge signals detected at a center pixel as a function of the amplitudes of the corresponding secondary signals measured its nearest neighbor that was derived from the results of Monte Carlo simulations of photon detection events.

FIG. 11A is a pot illustrating the amplitudes of primary and secondary charge signals mapped onto depth-of-interaction (DOI) that is derived from simulated photon interaction events.

FIG. 11B is a plot showing the ratios of the secondary signals to the primary signals mapped to the DOI value for each detected photon that is derived from simulated photon interaction events.

FIG. 11C is a plot showing a penetration parameter as a function of the penetration depth that is derived from simulated photon interaction events.

FIG. 12 illustrates simulated energy spectra based on Monte-Carlo simulated measurements of Barium isotopes having a peak gamma photon emission energy of 356 keV using a state-of-the art detector array and a detector array that provides compensation for depth-of-interaction (DOI) effects in accordance with an embodiment of the present disclosure.

FIG. 13 is a flow diagram illustrating an exemplary embodiment of a method for detecting ionizing radiation using a pixelated detector array in accordance with an embodiment of the present disclosure.

FIG. 14 is a flow diagram illustrating an exemplary embodiment of a method for detecting ionizing radiation using a pixelated detector array in accordance with an embodiment of the present disclosure.

FIG. 15 is a component block diagram illustrating an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims. Any reference to claim elements in the singular, for example, using the articles “a,” “an,” or “the” is not to be construed as limiting the element to the singular. The terms “example,” “exemplary,” or any term of the like are used herein to mean serving as an example, instance, or illustration. Any implementation described herein as an “example” is not necessarily to be construed as preferred or advantageous over another implementation. The drawings are not drawn to scale. Multiple instances of an element may be duplicated where a single instance of the element is illustrated, unless absence of duplication of elements is expressly described or clearly indicated otherwise.

Various embodiments of the present disclosure include detector arrays, such as pixilated CZT radiation detector arrays, used in gamma imaging systems having improved Detector Quantum Efficiency (DQE) and methods of operating thereof with DOI effect correction.

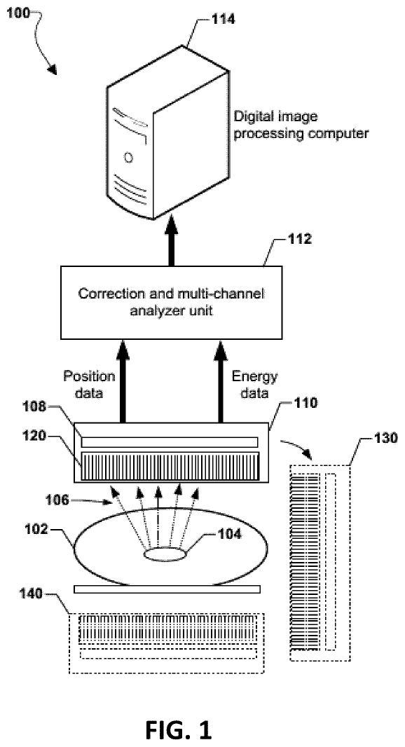

FIG. 1 is a functional block diagram of a SPECT imaging system 100. In a SPECT imaging system 100, a subject 102 (e.g., a human or animal patient) may be injected with a radiopharmaceutical containing a radioisotope, such as technetium 99, that is chemically configured to be absorbed by an organ or tumor to be examined, creating a concentrated radiation source 104. The radiopharmaceutical within the source organ 104 emits gamma rays 106 that are detected by a digital radiation detector 108 within a gamma camera 110. Count and energy data from individual pixels within the digital radiation detector 108 are provided to an analyzer unit 112 that analyzes the detector data to determine the count and energy spectrum of detected gamma rays and provides the analyzed data to a digital imaging system computer 114. The analyzer unit 112 may apply calibration corrections including, for example, determining corrections for charges shared between pixels and/or for the DOI effect according to various embodiments.

The SPECT imaging system 100 may also include additional structures, such as a collimator 120 within the gamma camera 110 and a robotic mechanism (not shown) that is configured to position the gamma camera 110 over the subject 102 at a variety of orientations (as illustrated as positions 130 and 140). Positioning the gamma camera 110 at various orientations with respect to the subject 102 enables gamma ray count and energy data to be acquired by the multi-pixel detector 108 from several different angles. Data collected in this manner can then be processed by the digital image system computer 114 to construct a 3D image of the organ or tumor 104 where the radiopharmaceutical has accumulated.

Various alternatives to the design of the SPECT imaging system 100 of FIG. 1 may be employed to practice embodiments of the present disclosure. For example, in industrial applications, such as luggage screening, the gamma source 104 may be positioned on a far side of the object being scanned with respect to the gamma camera and the gamma photons 106 imaged by the detector 108 may be photons that have passed through the object instead of being emitted from the object. In such applications, the gamma source 104 and gamma camera 110 may be both rotated about the object, such as on a rotating frame or gantry. Further, various other types of systems that include a gamma camera that uses a solid-state pixilated radiation detector may benefit from various embodiments, particularly for calibrating the radiation detector during manufacture or in service.

The detector 108 of a SPECT imaging system 100 may include an array of radiation detector elements, referred to as pixel sensors. The signals from the pixel sensors may be processed by a pixel detector circuit, such as an analyzer unit 112, which may sort detected photons into energy bins based on the energy of each photon or the voltage generated by the received photon. When a gamma photon is detected, its energy is determined and the photon count for its associated energy bin is incremented. For example, if the detected energy of a photon is 64 kilo-electron-volts (keV), the photon count for the energy bin of 60-80 keV may be incremented. The number of energy bins may range from one to several, such as two to six. The greater the total number of energy bins, the better the energy spectrum discrimination. Thus, the detector 108 of a gamma ray camera 110 provides information regarding both the location (within pixels) of gamma photon detections and the energy of the detected gamma photons.

While the radiation detector 108 of one embodiment described above is located in a gamma ray camera 110 of a gamma ray detection system, such as a SPECT system 100, in other embodiments the radiation detector 108 may be located in other radiation detection systems. For example, the radiation detector 108 may comprise an X-ray radiation detector which is located in an X-ray radiation detection system. Any suitable X-ray radiation detection system may be used, such a medical, industrial or baggage inspection system.

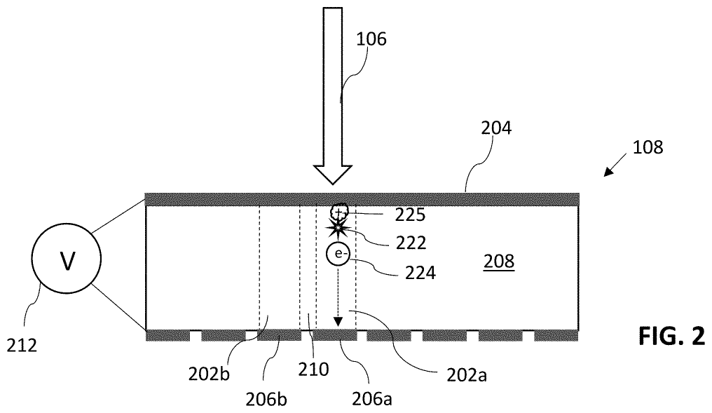

FIG. 2 illustrates a cross-sectional view of two pixels 202a, 202b within a radiation detector array 108, such as a CZT radiation detector array. Such a detector 108 may include a CZT semiconductor crystal 208 (e.g., a plate shaped CZT substrate) containing an electrically conductive cathode 204 on its front major surface (e.g., the surface facing the incoming radiation) and the anodes 206a, 206b that define each pixel 202a, 202b located on the opposing rear major surface. The anodes 206a, 206b may be spaced apart by an inter-pixel gap 210. In typical radiation detector arrays 108, the thickness of the CZT semiconductor crystal 208 may range from 1 mm to 20 mm, the anodes 206a, 206b may have a side dimension (e.g., length) of 0.1 mm to 3 mm, and the inter-pixel gap 210 may range from 0.01 mm to 0.5 mm. The cathode and the anodes are biased with an opposite polarity voltage from a voltage source 212.

When a photon of radiation (e.g., a gamma ray) 106 is absorbed at location 222 by an atom within the CZT semiconductor crystal 208, a cloud of electrons 224 is ejected into the conduction band of the semiconductor. Each ejected electron 224 creates a corresponding hole 225 of positive charge. The voltage is applied between the cathode 204 and anodes 206a, 206b causes the electrons 224 to drift to the anode 206a where they are collected as a signal as described above. Diffusion and charge repulsion forces cause the electron cloud to expand (as shown at 226) by the time the electrons reach the anode 206a. Holes 225 similarly migrate towards the cathode 204.

Various embodiments of the present disclosure may provide an increase in Detector Quantum Efficiency (DQE) of an ionizing radiation detector array, such as a CZT radiation detector array 108 as described above with reference to FIG. 2. In various embodiments, the DQE of the radiation detector array 108 may be increased by 10-20% or more for standard radioisotopes used for SPECT imaging, such as Technetium Tc-99^{m}, which has a peak gamma emission energy of 140 keV. For higher-energy isotopes, such as Lutetium Lu¹⁷⁷ (208 keV), Iodine I¹³¹ (364 keV) and Actium Ac²⁵⁵ (440 keV), which are used in theranostics applications, the increase in DQE of the radiation detector array 108 may be larger, and in some cases the DQE may be increased by a factor of two or more relative to conventional detector systems.

For example, the radioisotope Iodine I¹³¹ is used to treat thyroid cancer, and has a gamma emission peak at 364 keV. Many of the radioisotopes used as theranostic agents, such as Iodine I¹³¹, have very short half-lives, such as on the order of hours. Accordingly, many of the simulations described herein may use a more stable isotope, such as Barium which has a gamma emission peak at 356 keV, as representative of the types of theranostic agents that are used in clinical practice.

The DQE of a detector array is typically measured using a spectroscopic gamma source, such Am²⁴¹ or Co⁵⁷, having a defined emission energy (e.g., 60 keV and 122 keV, respectively, in the cases of Am²⁴¹ and Co⁵⁷). The DQE may be calculated by measuring the radiation spectrum of the spectroscopic gamma source using the detector array and identifying the peak energy of the measured spectrum. A window around the peak energy, such as +/−5% of the peak energy, may be defined, and the number of detected photons (A) within the defined energy window may be counted. The total number of photons that are emitted by the radiation source and impinge on the detector surface (B) may be calculated based on the source activity strength and the detector geometry. The DQE may be calculated as the ratio of A/B, and may be expressed as a percentage between 0-100%. Detectors used today for SPECT imaging typically have a DQE between 10-90%, depending on the particular detector and radiation source.

In practice, radioisotopes used as gamma sources may emit radiation at multiple peak energies, so the calculations of the DQE have to be adjusted accordingly. For example, for Co⁵⁷ efficiency is defined as the ratio of counts in peak area of ±5% Ep energy window (around the peak energy Ep), relative to the total number of gamma photons crossing the plane of the crystal face. To avoid ambiguity, this definition should clearly refer to 122 keV photons only. It is important since Co⁵⁷ emits some photons at other energies, and the photons emitted at 122 keV constitute only 85.6% of the total.

As mentioned above, the DQE of real-world radiation detectors is always less than 100%. This is due to a variety of factors. For example, not all photons which pass through the detector get absorbed. Some number of photons will pass straight through the detector without interacting with any atoms of the detector semiconductor crystal, and thus will not register as a photon count. The number of photons that are not absorbed by the detector may be reduced by making the detector thicker, although this may not be economical due to the relatively high cost of semiconductor crystal detector materials. In many cases, up to 5% of the total photon count may be lost due to non-absorption by the detector.

Another factor that results in a reduction in DQE is charge-sharing effects. As discussed above with reference to FIG. 2, during an interaction event between an incident photon 106 and an atom of the detector semiconductor crystal 208, clouds of charge carriers (i.e., electrons 224 and holes 225) are ejected and drift towards the respective anode 206 and cathode 204 electrodes. Due to diffusion and charge repulsion forces, the clouds of charge carriers may expand such that by the time the charge carriers reach the respective electrodes 206, 204, the cloud of charge carriers may extend outside of the boundaries of the pixel 202a in which the interaction event occurred at location 222. This is an undesirable phenomenon because the original charge induced in the detector semiconductor crystal 208 may be split between multiple pixels 202a, 202b, which may register simultaneous counts at lower energies than the energy of the original photon. Additional charge may be lost within the inter-pixel gap(s) 210 between adjacent pixels 202a, 202b of the detector. Thus, measured energy of the incoming photon may be registered with incorrect energy information, which may result in a reduction of DQE. Various techniques have been developed to compensate for charge-sharing effects. For example, one general technique for compensating for charge-sharing effects includes summing the measured charges from a group of neighboring pixels, and allocating the summed charge to the pixel with the highest amount of charge received. Other charge-sharing compensation methods have been developed, such as described in U.S. Pat. Nos. 10,393,891, 10,928,527 and 11,246,547 and in U.S. Patent Application Publication Nos. 2021/0063589 and 2020/0367839, the entire teachings of which are incorporated herein by reference. These techniques may help to mitigate the reduction in DQE resulting from charge-sharing effects.

Another factor that can reduce the DQE of the detector array is charge trapping effects. In particular, some electrons 224 may temporarily become trapped due to defects and/or imperfections (e.g., lattice defects) in the detector semiconductor crystal 208, and then may later become de-trapped and drift to the anode electrode 206a. However, in some cases, at least a portion of the trapped electrons 224 may not reach the anode electrode 206a until a subsequent read-out cycle of the detector circuitry to register photon counts has commenced. Thus, the energy information that is registered for the initial photon count may not be accurate, which may result in a reduction of the DQE, although in CZT detectors this effect is typically small.

A more significant factor in the reduction of DQE is the Depth of Interaction (DOI) effect. The Depth of Interaction (DOI) effect results from the imperfect drift of the charge carriers (i.e., electrons and holes), and is highly dependent on the location 222 (i.e., depth of location) within a given pixel 202a, 202b in which the photon interaction event occurs. In particular, for each photon interaction event, both electrons and holes contribute to the signal that is detected by the detector read-out circuitry, which may include charge-sensitive amplifiers (CSAs) electrically coupled to the anodes of the pixels of the detector array. The proportion of the contributions of electrons and holes to the detected signal varies as a function of the depth within the pixel in which the photon interaction event occurs. This is because the typical trapping length of the holes is much shorter than the trapping length of the electrons. This means that the majority of the electrons are able to quickly reach the anode electrode of the pixel regardless of where the photon interaction occurs within the pixel. However, for photon interactions that occur relatively deeper within the pixel (e.g., closer to the anode electrode), the holes have to travel further to reach the cathode, and there is a higher probability that the holes will become trapped. Thus, it may take significantly longer for all the holes to be collected at the cathode, including longer than the read-out (e.g., charge integration) cycle of the detector circuitry. This may lead to significant errors in the photon energy measurement. In particular, a low energy tail resulting from holes which do not reach the cathode during the same read-out cycle as the photon interaction event which produced them, may be generated in the measured energy spectrum.

Accordingly, the amplitude of the detected signal is higher when the photon interaction occurs close to the cathode since the holes are more likely to reach the cathode electrodes without becoming trapped. However, the amplitude of the detected signal is lower when the photon interaction occurs close to the anode since the holes have to travel a greater distance and are more likely to be trapped than the electrons.

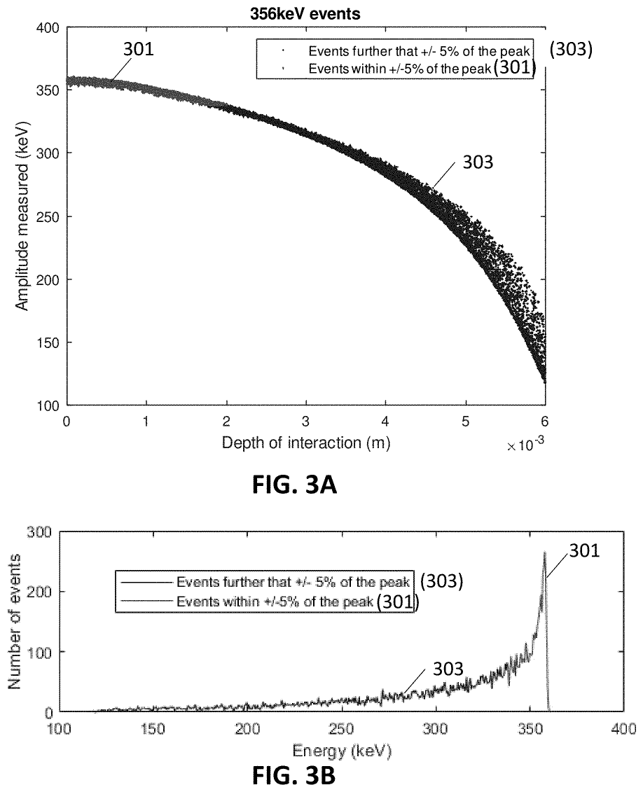

This effect is illustrated in FIG. 3A, which is plot of Monte-Carlo simulations of the amplitudes of the signal induced on a pixel by a radiation source having a peak gamma emission energy of 356 keV versus the depth of interaction of photon interaction events (where x=0 is the position of the cathode and x=6 mm is the position of the anode). The simulated detector is 6 mm thick with a pixel pitch of 2.46 mm and the μ·τ product for electrons and holes are respectively 2×10⁻² cm² V⁻¹ and 8×10⁻⁵ cm² V⁻¹ (which are typical values measured in a low flux CZT detector). Each of the red dots 301 represents a simulated photon interaction event in which the amplitude of the induced signal is within the defined energy window of +/−5% of the 356 keV peak energy, and each of the blue dots 303 represents a simulated photon interaction event in which the amplitude of the induced signal is outside of the defined energy window of +/−5% of the 356 keV peak energy. Thus, the blue dots 303 do not contribute to the total count of detected photons (A) within the defined energy window. The relatively large number of blue dots 303 indicates a lower DQE, since, as discussed above, DQE is defined as the ratio of the count of detected photons (A) within the energy window to the total number of photons impinging on the detector surface (B).

FIG. 3A illustrates the high dependence of the amplitude of the induced signal on the depth of the photon interaction event within the detector. As shown in FIG. 3A, nearly all of the red dots 301 indicate photon interaction events occurring within ˜2 mm of the cathode, whereas the majority of the photon interaction events occurring within ˜4 mm of the anode produce signal amplitudes outside of the defined energy window (i.e., blue dots 303), and thus do not contribute to the total count of detected photons (A).

FIG. 3B is plot of the Monte-Carlo simulations of FIG. 3A showing the total number of simulated photon energy measurements at different energies between 100 keV and 400 keV. As shown in FIG. 3B, the highest numbers of photon interaction events are measured at energies within the defined energy window of 338 keV to 374 keV (which are within 5% of 356 keV, and indicated in red in FIG. 3B), but the long tail of photon interaction events measured at lower energies that are outside of the energy window (i.e., below 338 keV and indicated in blue in FIG. 3B) results in a significant decrease in DQE. It is estimated that up to 40% or more of the total loss in DQE relative to an “ideal” detector may be due to a combination of charge sharing and DOI effects.

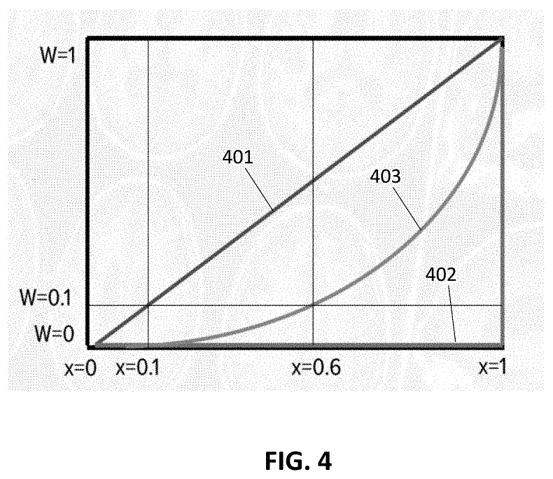

The DOI effect may also be demonstrated using weighting potential, w. The weighting potential is not a real electrostatic potential, but rather an abstract construct that allows one to calculate the amount of induced charge on the electrode of interest. The weighting potential, w, may be considered the effective potential that the charge carriers “see” as they drift toward the anode and cathode electrodes within a detector pixel. FIG. 4 is a plot of the weighting potential, w, versus the depth of interaction of photon interaction events (where x=0 is the position of the cathode and x=1 is the position of the anode) for three different detectors. The horizontal line at w=0.1 indicates which photons are measured at the peak energy, where weighting potentials ≤0.1 are measured at the peak energy and weighting potentials >0.1 are measured below the peak energy. The location of this cut-off line is arbitrary (i.e., it could be at any value of w). The more tightly-constrained the peak energy window is defined, the lower the w value is at the cut-off line.

Referring to FIG. 4, line 401 illustrates the weighting potential distribution of a planar (i.e., non-pixelated) detector, line 402 illustrates the weighting potential distribution of an ideal detector, and line 403 illustrates the weighting potential distribution of a realistic pixelated detector. As shown in FIG. 4, the weighting potential distribution of the planar detector (line 401) increases linearly as a function of the depth of interaction of photon interaction events. The planar detector exhibits a dramatic loss in efficiency, with only the photon interaction events occurring within a depth of 10% of the total detector thickness between the cathode and the anode contributing to the peak energy measurements. The ideal detector (line 402) exhibits 100% efficiency such that photon interaction events occurring throughout the entire detector thickness contribute to the peak energy measurements. For a realistic pixelated detector (line 403), only photon interaction events occurring within a depth of ˜60% of the total detector thickness between the cathode and the anode contribute to the peak energy measurements.

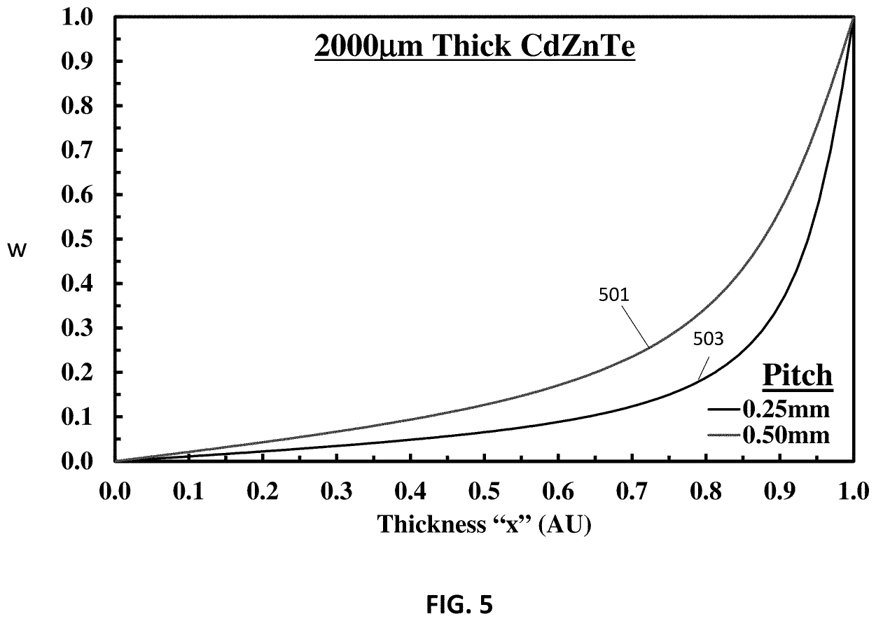

FIG. 5 is a plot illustrating the weighting potential distributions of two pixelated detectors having different pixel pitches. Line 501 shows the weighting potential distribution of a pixelated CZT detector having a thickness of 2,000 μm and a pixel pitch of 500 μm and line 503 shows the weighting potential distribution of a pixelated CZT detector having a thickness of 2,000 μm and a pixel pitch of 250 μm. As shown in FIG. 5, the detector having the smaller pixel pitch (line 503) has a more confined weighting potential distribution—that is, closer to the weighting potential distribution of an “ideal” detector as shown in FIG. 4, than the detector having the larger pixel pitch (line 501). This is sometimes referred to as the “small pixel effect,” where a detector having relatively smaller pixels with a smaller inter-pixel pitch may have a reduction in the DOI effect, which may provide improved efficiency. However, there is a tradeoff in that smaller pixel sizes and pixel pitches may increase the charge-sharing effect. Further, even with the moderate improvement in weighting potential distribution of the detector having a pixel pitch of 250 μm (line 503) relative to the detector having a pixel pitch of 250 μm (line 501), the DQE of the detector with the pixel pitch of 250 μm is still rather poor, with many photon interaction events occurring close to the anode electrode not being registered within the peak energy window.

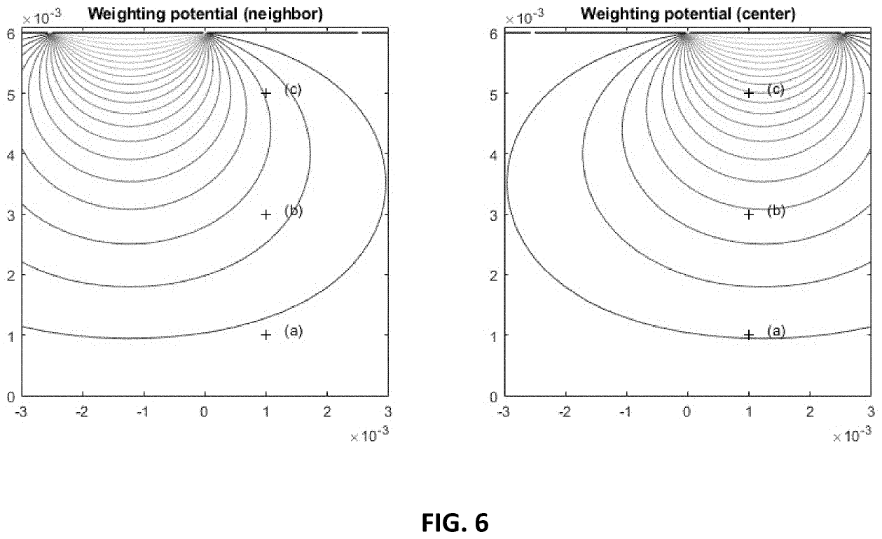

Weighting potential simulations may be performed in two dimensions to provide insight into the behavior of a detector pixel and its neighbor(s). FIG. 6 shows plots of two-dimensional weighting potential distributions of a center detector pixel (right hand side) and a neighboring detector pixel (left hand side). The y-axis depicts the depth within the center and neighboring pixels, where 0 mm is the cathode-side and 6 mm is the anode-side. The x-axis indicates the lateral position within the center and neighboring pixels (i.e., in a horizontal plane parallel to the surface of the pixel). The curved lines are equipotentials (which may also be referred to as isopotentials) of the weighting potential of the center and neighboring pixels. FIG. 6 illustrates three photon interaction events occurring at three different depths: (a) 1 mm, (b) 3 mm, and (c) 5 mm.

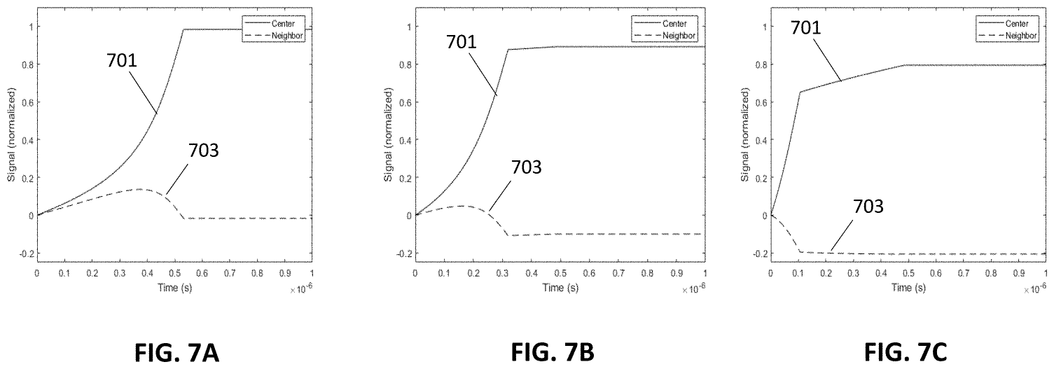

FIGS. 7A-7C are plots showing the charge signal evolution over time in the center pixel and the neighboring pixel in the simulation of FIG. 6 as electrons travel to the anode electrode over a 1 microsecond interval following photon interactions occurring at depths of 1 mm (FIG. 7A), 3 mm (FIG. 7B), and 5 mm (FIG. 7C) from the cathode. In each of FIGS. 7A-7C, line 701 illustrates the (normalized) charge signal (i.e., current or voltage) in the center pixel, and line 703 illustrates the (normalized) charge signal (i.e., current or voltage) in the neighboring pixel. In each of these cases, the photon interaction event occurs within the center pixel, and thus the magnitude of the signal 701 in the center pixel is larger than the magnitude of the signal(s) 703 in its neighboring pixel(s). Accordingly, the signal 701 in the center pixel may be referred to as the “primary signal,” and the signals 703 in the neighboring pixel may be referred to as a “secondary signal.”

As shown in FIG. 7A, for a photon interaction event occurring at a depth of 1 mm, the normalized primary charge signal 701 in the center pixel is 1, while the normalized secondary charge signal 703 in the neighboring pixel is 0. This is to be expected for a photon interaction occurring close to the cathode. In this case, the interaction event would be registered within the peak energy window, and thus would contribute to the DQE of the detector. In FIG. 7B, where the photon interaction event occurs at a depth of 3 mm, the normalized primary charge signal 701 in the center pixel is ˜0.9, while the normalized secondary charge signal 703 in the neighboring pixel is ˜−0.1. From an efficiency perspective, this is a borderline photon interaction event, which may or may not contribute to the DQE of the detector depending on how wide the peak energy window is defined. In FIG. 7C, where the photon interaction event occurs at a depth of 5 mm, the normalized primary charge signal 701 in the center pixel is ˜0.8, while the normalized secondary charge signal 703 in the neighboring pixel is ˜−0.2. This photon interaction event would be measured outside of the peak energy window due to the DOI effect and would not contribute to the DQE of the detector.

The present inventors realized that in both of the cases illustrated in FIGS. 7B and 7C, where the photon interaction occurs relatively deep within the center pixel, the secondary charge signal 703 in the neighboring pixel is both non-zero and has the opposite polarity of the polarity of the primary charge signal 701 in the center pixel. Thus, for photon interaction events located deep in the central pixel (e.g., relatively close to the anode and relatively far from the cathode), a secondary charge signal 703 of opposite polarity to the primary charge signal 701 is observed. For example, the primary charge signal 701 may be negative voltage while the secondary charge signal 703 may be a positive voltage. In other words, opposite polarity signals for the primary and secondary charge signals indicate presence of the DOI effect.

Various embodiments of the present disclosure include pixelated detectors and methods of detecting radiation using a pixelated detector that provide improved efficiency by including a DOI correction. In accordance with various embodiments of the present disclosure, the primary charge signal and at least one secondary charge signal from a neighboring pixel may be measured in response to a photon interaction event. When the at least one measured secondary charge signal from the neighboring pixel has the opposite polarity of the primary charge signal, a corrected charge signal for the photon interaction event may be generated by applying a correction to the primary charge signal based on the magnitude of the at least one secondary charge signal. In some embodiments, applying the correction to the primary charge signal may include subtracting the secondary charge signal from the primary charge signal (or equivalently, summing the absolute values of the primary charge signal and the secondary charge signal). Thus, in the example of FIG. 7C, where the normalized primary charge signal 701 in the center pixel is 0.8 and the normalized secondary charge signal 703 in the neighboring pixel is −0.2, the (normalized) corrected charge signal may be 0.8−(−0.2), or 1.0. The (normalized) corrected charge signal of 1.0 is within the peak energy window, and thus contributes to the DQE of the detector. Alternatively without using normalization the primary charge signal 701 in the center pixel is −0.8 (e.g., negative 0.8V) and the secondary charge signal 703 in the neighboring pixel is +0.2 (e.g., positive 0.2V), then the corrected charge signal may be −0.8 −0.2, or −1.0. Accordingly, various embodiments may be used to compensate for depth-of-interaction effects and thereby improve overall detector efficiency.

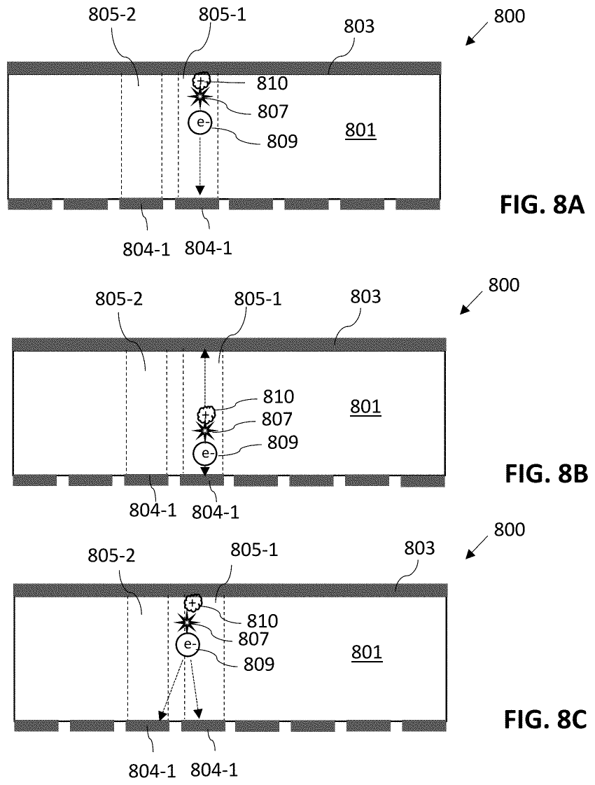

FIGS. 8A-8C are vertical cross-section views of a pixelated radiation detector array 800 according to various embodiments of the present disclosure. The detector array 800 of FIGS. 8A-8C may be similar to the detector array 108 described above with reference to FIG. 2, and may include a semiconductor crystal material 801, such as CZT, having a cathode electrode 803 over a first (e.g., front) side surface of the semiconductor crystal material 801 and a plurality of anode electrodes 804 over a second (e.g., back) side surface of the semiconductor crystal material 801. Each of the anode electrodes 804 may define an individual pixel 805-1, 805-2 of the detector array 800.

FIGS. 8A-8C illustrate three different scenarios of photon interaction events 807 occurring within a pixelated detector array 800. FIG. 8A illustrates a first scenario in which a photon interaction event 807 occurs near the cathode electrode 803 of the detector array 800 and within the central region of a first pixel 805-1. The photon interaction event 807 produces electrons 809 which quickly travel to the anode electrode 804-1 of the first pixel 805-1, and holes 810 which more slowly drift towards the cathode electrode 803. Because the photon interaction event 807 occurs in the central region of the first pixel 805-1, the electron cloud does not extend outside of the first pixel 805-1. This may be referred to as a Single Pixel Event (SPE). Moreover, because the holes 810 are already close to the cathode electrode 803, all or nearly all of the holes 810 are able to reach the cathode electrode 803 during the read-out cycle of the detector circuitry, and hole trapping effects are negligible. Thus, the primary charge signal detected at the anode electrode 804-1 of the first pixel 805-1 may be directly proportional to the full photon energy Eₚₕ of the incident photon. No secondary signals resulting from the photon interaction event 807 may be detected in any of the neighboring pixels. The primary charge signal detected at the anode electrode 804-1 of the first pixel 805-1 may have a first polarity, which in the detector configuration shown in FIGS. 8A-8C may be a negative polarity. This scenario of FIG. 8A should produce a signal profile similar to that shown in FIG. 7A and described above.

FIG. 8B illustrates a second scenario in which a photon interaction event 807 occurs near the anode electrode 804-1 of the detector array 800. The photon interaction event 807 produces electrons 809 which quickly travel to the anode electrode 804-1 of the first pixel 805-1, and holes 810 which more slowly drift towards the cathode electrode 803. Due to the depth of the photon interaction event 807, the holes 810 must travel a relatively long distance to the cathode electrode 803, and hole trapping effects are significant. A large number of holes 810 may not reach the cathode electrode 803 during the read-out cycle of the detector circuitry and thus may not contribute to the detected signal. Accordingly, the signal detected at the anode electrode 804-1 of the first pixel 805-1 may represent an energy that is significantly less than the full photon energy Eₚₕ of the incident photon. In addition, a secondary signal may be detected at the anode electrodes 804-2 of one or more neighboring pixels, such as pixel 805-2 in FIG. 8B. The secondary signal detected at the anode electrode 804-2 of neighboring pixel 805-2 may have a smaller amplitude than, and an opposite polarity to, the primary signal detected at the anode electrode 804-1 of pixel 805-1. For example, where the primary signal has a negative polarity, the secondary signal(s) detected in one or more neighboring pixels 805-2 may have a positive polarity due to the depth-of-interaction effect described above. This scenario of FIG. 8B should produce a signal profile similar to that shown in FIG. 7C and described above.

FIG. 8C illustrates a third scenario in which a photon interaction event 807 occurs near the boundary of a first pixel 805-1 of the detector array 800. As in the scenarios shown in FIGS. 8A and 8B, electrons 809 move towards the anode-side of the detector array 800 and holes 810 move toward the cathode electrode 803. In this scenario shown in FIG. 8C, as the electrons 809 move toward the anode-side of the detector array 800, the cloud of electrons 809 diffuses such that only a portion of the electrons 809 reach the anode electrode 804-1 of the first pixel 805-1. A second portion of the electrons 809 may reach the anode electrode 804-2 of the adjacent pixel 805-2. This is an example of a charge sharing event (CSE). Accordingly, the signal detected at the anode electrode 804-1 of the first pixel 805-1 may represent an energy that is less than the full photon energy Eₚₕ of the incident photon due to the charge sharing effect. In addition, a secondary signal may be detected in one or more neighboring pixels, such as pixel 805-2, that are close to the photon interaction event 807. Each secondary signal detected at an anode electrode 804-2 of the one or more neighboring pixels 805-2 may have a smaller amplitude than the primary signal, and may have the same polarity as the primary signal. For example, where the primary signal has a negative polarity, the secondary signal(s) detected in one or more neighboring pixels 805-2 may also have a negative polarity. This scenario of FIG. 8C should produce a signal profile different from that shown in FIGS. 7A-7C and described above.

Referring again to FIGS. 7A-7C and 8A-8C, in response to a photon interaction occurring within a first pixel 805-1, an electron cloud is generated and begins moving towards the anode electrode 804-1 of the first pixel 805-1 as well as towards the anode electrode 804-2 of its neighboring pixel 805-2. While the moving cloud is still far away from the anode electrodes 804-1 and 804-2, the cloud starts to induce charges on the anode electrodes 804-1 and 804-2 of both of the pixels 805-1 and 805-2 to almost the same degree. For example, as shown in FIG. 7A, up to about 300 ns following the photon interaction event, the primary signal 701 on the first pixel 805-1 and the secondary signal 703 on its neighbor pixel 805-2 are both rising at similar rates, meaning that similar charges are being induced on both anodes. However, shortly after 400 ns, both depart dramatically, as the primary signal 701 on the first pixel 805-1 quickly increases towards 1 while the secondary signal 703 on the neighboring pixel 805-2 drops towards its final value of 0. This indicates that the charge-cloud lands completely on the first pixel 805-1. An important observation is that the neighboring pixel 805-2 sees the transient signal, and capturing that signal may provide novel detection possibilities.

The above case represents the situation in which the photon interaction event occurs close to the cathode 803 of the first pixel 805-1, such as illustrated in FIG. 8A. However, the situation changes significantly when the photon interaction event occurs closer to the anode, as shown in FIG. 8B. In this situation, the first pixel 805-1 collects most of the electrons, but the trapping of the holes has a significant effect on the amplitude of the charge induced on the anode 804-1 of the first pixel 805-1. This is because the photon interaction event occurs close to the anode where the weighing potential changes significantly.

As described above, this effect causes low energy tail in the measured spectra as the signal is not fully developed. The low energy tail is strongly influenced by the value of Mu*Tau holes. Thus, the secondary signal 703 on the neighboring pixel 805-2 sees an initial transient rise and then goes below 0. Further, the magnitude of this negative charge induced on the neighboring pixel 805-2 increases with the corresponding change in the amplitude of the charge detected on the first pixel 805-1, as is illustrated in FIGS. 7B and 7C.

The balance between primary signal 701 induced in the first pixel 805-1 and one or more secondary signals 703 induced in neighboring pixels (e.g., pixel 805-2) is dependent on the location of the photon interaction event within the first pixel 805-1. For example, in a situation in which the photon interaction event occurs near the boundary of the first pixel 805-1, such as illustrated in FIG. 8C, a secondary signal 703 is most likely to be induced in neighboring pixel(s) that are closest to the boundary.

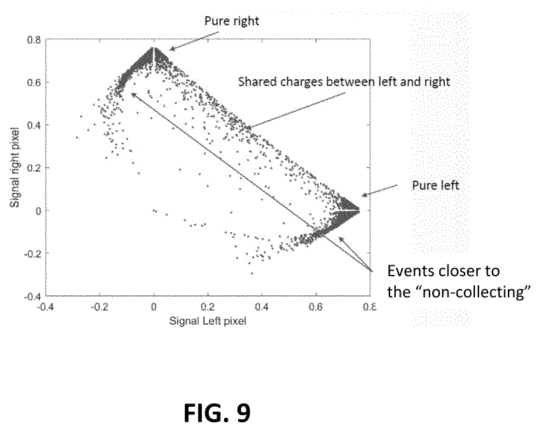

FIG. 9 is a scatter plot of several hundred of simulated photon interaction events occurring in different locations (e.g., X, Y positions). As illustrated in FIG. 9, there are events in which charge lands on just one pixel or is shared by two adjacent pixels. In addition, there may be events in which the secondary signal induced in one neighboring pixel has the same polarity as the primary signal (indicating a charge sharing event) while the secondary signal induced in another neighboring pixel has the opposite polarity (indicating a depth-of-interaction-related charge-loss on the primary charge signal).

An exemplary implementation of a method for providing corrected photon energy measurements that may compensate for both charge sharing and depth-of-interaction effects may include determining the pixel that received the incident photon (which may also be referred to as the “center pixel” or the “first pixel”) and detecting the amplitude of the primary charge signal induced in this pixel. This may be triggered, for example, when the primary charge signal on the center pixel is detected with the primary polarity (e.g., a negative voltage) above a threshold amplitude and/or rate of increase indicating that a photon has landed within the pixel. The amplitudes of secondary charge signals induced on a set of neighboring pixels of the center pixel may also be detected (e.g., during the same read-out cycle of the detector circuitry). The set of neighboring pixels may include, for example, pixels that are immediately adjacent to the center pixel, such as the pixels to located the left and right and/or above and below the center pixel when the detector array is viewed from below (i.e., facing the anode electrodes). In some embodiments, the set of neighboring pixels may also include pixels that are diagonally adjacent to the center pixel. In general, the set of neighboring pixels may include at least 2 pixels, such as 4-8 pixels, that are located near or adjacent to the pixel that received the incident photon.

The secondary charge signals that are induced the neighboring pixels may have the same polarity as the primary charge signal induced in the center pixel, or may have the opposite polarity as the primary charge signal induced in the center pixel. Thus, in various embodiments, the read-out circuitry of the detector array may be configured to detect both positive and negative charge signals for each pixel of the array. This may be implemented, for example, by utilizing a CMOS circuit design that includes proper definition of common-mode voltage of the input state of the Application Specific Integrated Circuit (ASIC) used to read-out the generated charge signals.

A corrected photon energy measurement may be calculated, for example, by adding the amplitudes of each secondary charge signal having the same polarity as the primary charge signal to the amplitude of the primary charge signal (e.g., to account for the charge sharing effect), and subtracting the amplitudes of each secondary charge signal having the opposite polarity as the primary charge signal from the amplitude of the primary charge signal (to account for the DOI effect). Equivalently, this may be expressed as summing the absolute value of the amplitude of the primary charge signal with the absolute values of the amplitudes of each of the secondary charge signals. Thus, for example, if the primary charge signal detected at the center pixel has a normalized amplitude of 0.7, and secondary charge signals having normalized amplitudes of 0.2 and −0.1 are detected on respective neighboring pixels, then the corrected photon energy measurement may be equal to 0.7+0.2−(−0.1), or 1.0.

In some embodiments, the amplitudes of at least some of the secondary charge signals detected by the neighboring pixels may be multiplied by a correction factor, k, prior to being summed. The correction factor, k, may be determined experimentally. In some embodiments, the correction factor, k, may only be applied to secondary charge signals having an opposite polarity than the primary charge signal. A separate correction factor may optionally be applied for secondary charge signals having the same polarity as the primary charge signal.

In some embodiments, a calibration process may be performed. The calibration process may include exposing the detector to a radioisotope source having a well-defined energy peak, such as ¹³³Ba or ⁵⁷Co. Photon interaction events which induce a secondary charge signal on a neighboring pixel having the opposite polarity than the polarity of primary charge signal detected on the center pixel may be identified. The amplitudes of the primary charge signals measured at the center pixel may plotted as a function of the amplitudes of the corresponding secondary charge signals measured at the neighboring pixels.

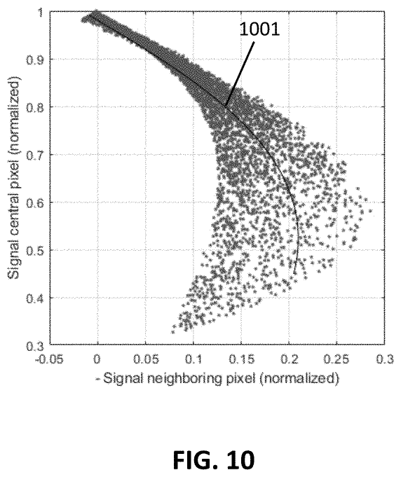

FIG. 10 illustrates a plot of amplitudes of primary charge signals detected at a center pixel as a function of the amplitudes of the corresponding secondary signals measured its nearest neighbor that was derived from the results of Monte Carlo simulations of photon detection events. The analytical function is shown as the black line 1001. Once determined, this fitted function may be used to evaluate the depth of interaction and in turn to make the energy correction described above.

A detector readout method as described above may also be used to extract depth information of photon interaction events in accordance with various embodiments. This may be important for certain applications, such as Compton cameras, which are gamma cameras used for astronomy, radiation therapy and other purposes. In such cameras, the depth of interaction is used to compute the direction of the incoming photon using angular resolution cones.

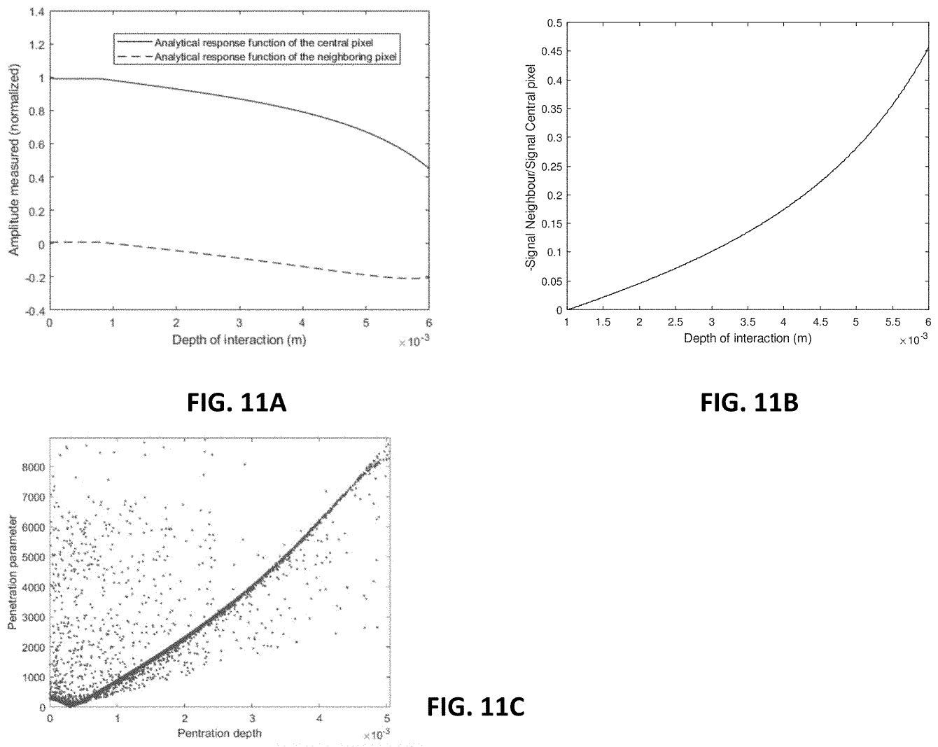

FIG. 11A is a plot illustrating the amplitudes of simulated primary and secondary charge signals mapped onto depth-of-interaction (DOI) of the simulated photon interaction events. Using the ratios of the secondary signals to the primary signals, a translation can be derived as shown in FIG. 11B that uniquely maps the signal ratio to the DOI value for each detected photon. In practice, there may be some variability (e.g., sensor to sensor, pixel to pixel) in the simulated curve due to various second order effects. A calibration procedure, such as using two or more radiation sources having known energy profiles, may be used to reduce this variability. A penetration parameter which is a function of the penetration depth may be derived from the translation, such as shown in FIG. 11C. This may provide fairly precise depth sensing, with a resolution of about 100 μm.

Various embodiments of the present disclosure may provide substantial benefits in detector efficiency over the photon energy ranges typically used in Nuclear Medicine applications, including applications utilizing Technetium Tc99m isotope (140 keV) that is injected into the patient. These benefits may be even more significant for higher energy isotopes that are currently being introduced into Nuclear Medicine due to trends in personalized medicine and corresponding theranostic applications in which alpha particles are used to kill cancer cells and gamma photons are used for quantification and localization purposes.

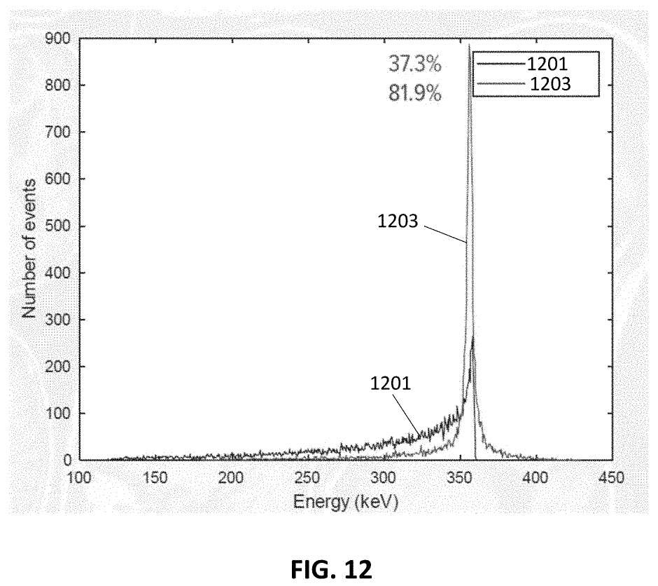

FIG. 12 illustrates simulated energy spectra based on Monte-Carlo simulated measurements of Barium isotopes having a peak gamma photon emission energy of 356 keV. As discussed above, Barium is a stable isotope that is often used as representative of the types of theranostic agents that are used in clinical practice, which typically have peak gamma photon emission energies in a range between 200 keV and 450 keV. Line 1201 illustrates the spectrum based on simulated measurements using a prior art technique that does not compensate for depth-of-interaction (DOI) effects. Line 1203 illustrates the spectrum based on simulated measurements in accordance with an embodiment method that provides compensation for depth-of-interaction (DOI) effects using secondary signals from neighboring pixels having the opposite polarity of the primary signal, as described above. The increase in the DQE of the detector using the embodiment detection technique is evident in the simulation of FIG. 12. In particular, the detector efficiency of 37.3% in the prior art method is increased to 81.9% in the embodiment method, which is a more than two-fold increase in DQE.

In addition to CZT detectors, the methods and systems described herein may be applicable to other types of detector systems, such as detector systems utilizing High-Z materials, such as Cadmium Telluride (CdTe), Thallium Bromide (TlBr), and Gallium Arsenide (GaAs). In addition, although the methods and systems of the present disclosure have been described in connection with relatively low-flux applications, such as gamma cameras, SPECT imaging and/or other Nuclear Medicine applications, the methods and systems may be used in other applications requiring detection of ionizing radiation, such as X-ray detectors, including X-ray Computed Tomography (CT) imaging applications.

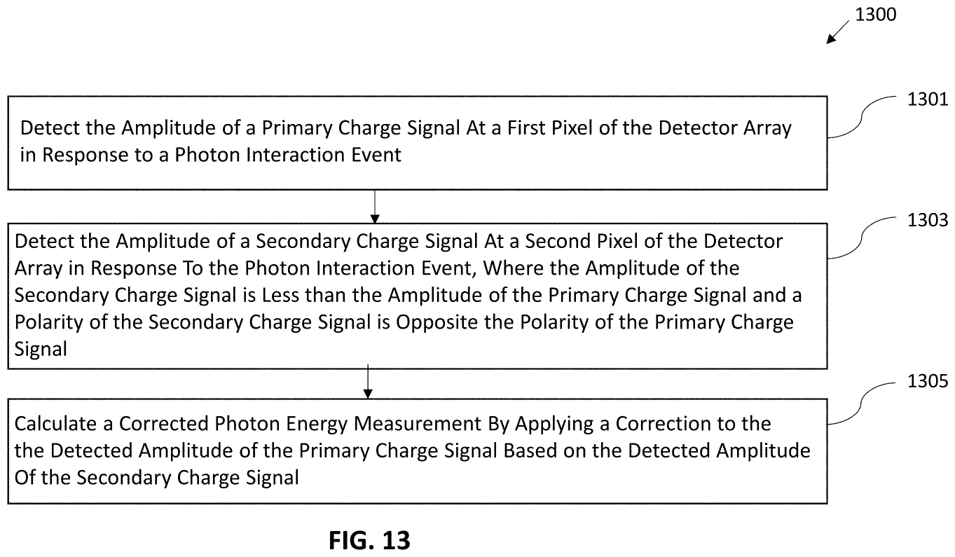

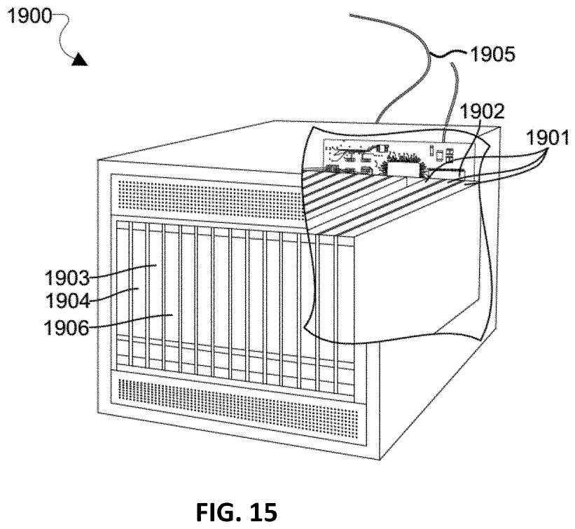

FIG. 13 is a flow diagram illustrating an exemplary embodiment of a method 1300 for detecting ionizing radiation, such as gamma radiation, using a pixelated detector array 800 such as shown and described above with reference to FIGS. 8A-8C. The method 1300 may provide improved detector quantum efficiency (DQE) by compensating for charge signal loss due to depth-of-interaction (DOI) effects. The method 1300 may be implemented using a suitable processing device (e.g., the analyzer unit 112 of FIG. 1 or the computing device 114 of FIG. 1 or 1900 of FIG. 15). In one non-limiting embodiment, the method 1300 may be implemented in an FPGA or similar processing device that may be coupled to the detector read-out circuitry. The detector read-out circuitry may include an application-specific integrated circuit (ASIC) coupled to each anode electrode of the detector array 108 or 800 and which may be configured to generate digital signals representing the charge (e.g., voltage and/or current) on each of the anode electrodes of the detector array. The processing device may be coupled to the output channels of the ASIC and may be configured to perform processing operations on the digital signals received from the output channels of the ASIC.

In step 1301 of embodiment method 1300, the amplitude of a primary charge signal may be detected at a first pixel of a detector array in response to a photon interaction event. The first pixel may be the pixel in which the photon interaction event occurs, and may be identified as the pixel having the highest amplitude charge signal within a given region of the detector array.

In step 1303 of embodiment method 1300, the amplitude of a secondary charge signal may be detected at a second pixel of the detector array in response to the photon interaction event, where the amplitude of the secondary charge signal is less than the amplitude of the primary charge signal and a polarity of the secondary charge signal is opposite the polarity of the primary charge signal. The second pixel may be a pixel that is proximate to the first pixel in the detector array (i.e., a neighboring pixel), such as a pixel that is laterally or diagonally adjacent to the first pixel. In various embodiments, the method 1300 may be implemented using a detector array having read-out circuitry that is configured to measure and distinguish between charge signals having positive and negative polarity. Thus, in embodiments in which the primary charge signal detected at the first pixel is negative, the secondary charge signal detected at the second pixel is positive, and vice versa.

In some embodiments, the amplitudes of secondary charge signals may be detected at multiple neighboring pixels of the first pixel. Each of the secondary charge signals may have a polarity that is opposite the polarity of the primary charge signal.

In step 1305 of embodiment method 1300, a corrected photon energy measurement may be generated by applying a correction to the detected amplitude of the primary charge signal based on the detected amplitude of the secondary charge signal. The correction applied to the detected amplitude of the primary charge signal may compensate for charge loss in the primary charge signal due to the depth-of-interaction (DOI) of the photon interaction event. In some embodiments, applying the correction may include subtracting the amplitude of the secondary charge signal from the amplitude of the primary charge signal (or equivalently, adding the absolute value of the secondary charge signal to the amplitude of the primary charge signal). In some embodiments, the amplitude of the secondary charge signal may be multiplied by an experimentally-derived correction factor prior to being subtracted from the amplitude of the primary charge signal. In some embodiments, the correction may be based on a function relating the amplitude of the secondary charge signal to charge loss in the primary charge signal due to depth-of-interaction (DOI) effects. The function may be derived using a prior calibration process.

In embodiments in which multiple secondary charge signals having the opposite polarity to the primary charge signal are detected in plural neighboring pixels, the correction to the detected amplitude of the primary charge signal may be based on the detected amplitudes of each of the secondary signals. For example, the amplitudes of each of the secondary charge signals may be subtracted from the amplitude of the primary charge signal.

In some embodiments, at least one secondary charge signal having the opposite polarity as the primary charge signal may be detected in one or more neighboring pixels, and at least one secondary charge signal having the same polarity as the primary charge signal may be detected in one or more neighboring pixels. The at least one secondary charge signal having the same polarity as the primary charge signal may be the result of a charge sharing event (CSE) between the first pixel and one or more neighboring pixels. In some embodiments, the correction applied to the detected amplitude may compensate for charge loss in the primary charge signal due to charge sharing between the first pixel and one or more neighboring pixels. In some embodiments, applying the correction may include subtracting the amplitude of each secondary charge signal having the opposite polarity as the primary charge signal from the amplitude of the primary charge signal (or equivalently, adding the absolute value of the secondary charge signal to the amplitude of the primary charge signal), and adding the amplitude of each secondary charge signal having the same polarity as the primary charge signal to the amplitude of the primary charge signal.

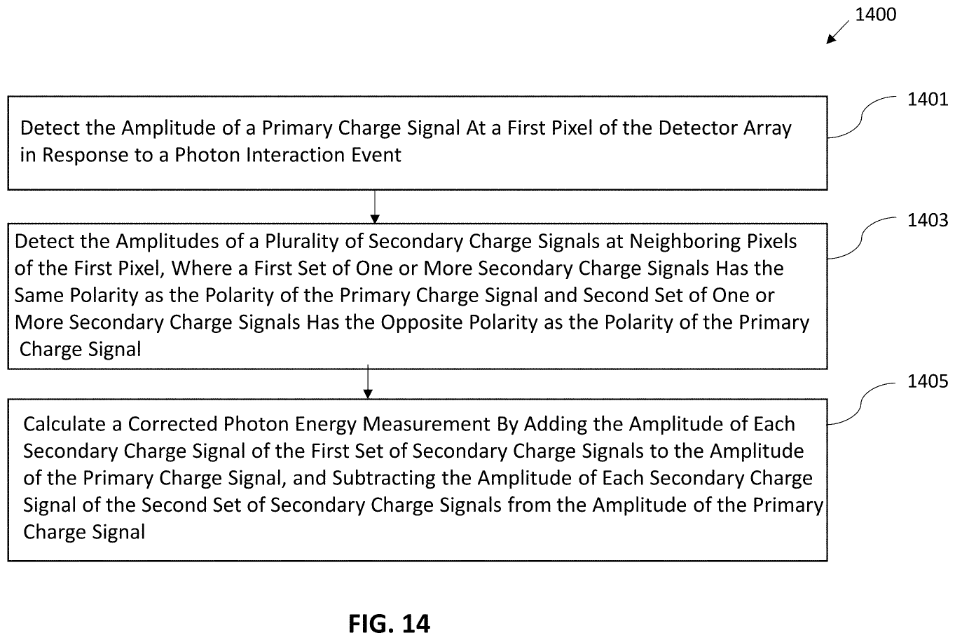

FIG. 14 is a flow diagram illustrating a method 1400 for detecting ionizing radiation, such as gamma radiation, using a pixelated detector array according to another embodiment of the present disclosure. The method 1400 may provide improved detector quantum efficiency (DQE) by compensating for charge signal losses due to both depth-of-interaction (DOI) and charge-sharing effects. The method 1400 may be implemented using a suitable processing device such as described above with reference to FIG. 13.

In step 1401 of embodiment method 1400, the amplitude of a primary charge signal may be detected at a first pixel of a detector array in response to a photon interaction event. The first pixel may be the pixel in which the photon interaction event occurs, and may be identified as the pixel having the highest amplitude charge signal within a given region of the detector array.

In step 1403 of embodiment method 1400, the amplitudes of a plurality of secondary charge signals may be detected at neighboring pixels of the first pixel. The neighboring pixels may include a group of pixels that are proximate to the first pixel in the detector array, such as pixels that are laterally or diagonally adjacent to the first pixel. A first set of one or more secondary charge signals may have the same polarity as the polarity of the primary charge signal. A second set of one or more secondary charge signals may have the opposite polarity of the polarity of the primary charge signal. In various embodiments, the method 1400 may be implemented using a detector array having read-out circuitry that is configured to measure and distinguish between charge signals having positive and negative polarity. Thus, in embodiments in which the primary charge signal detected at the first pixel is negative, the first set of one or more secondary charge signals may be negative and the second set of one or more secondary charge signals may be positive.

In step 1405 of embodiment method 1400, a corrected photon energy measurement may be generated by adding the amplitude of each secondary charge signal of the first set of secondary charge signals to the amplitude of the primary charge signal, and subtracting the amplitude of each secondary charge signal of the second set of secondary charge signals from the amplitude of the primary charge signal. In various embodiments, the correction applied to amplitude of the primary charge signal may compensate for charge losses due to both the depth-of-interaction (DOI) of the photon interaction event as well as charge sharing between the first pixel and one or more neighboring pixels.

The various embodiments (including, but not limited to, embodiments described above with reference to FIGS. 13 and 14) may also be implemented in computing systems, such as any of a variety of commercially available servers. An example server 1900 is illustrated in FIG. 19. Such a server 1900 typically includes one or more multicore processor assemblies 1901 coupled to volatile memory 1902 and a large capacity nonvolatile memory, such as a disk drive 1904. As illustrated in FIG. 19, multicore processor assemblies 1901 may be added to the server 1900 by inserting them into the racks of the assembly. The server 1900 may also include a floppy disc drive, compact disc (CD) or digital versatile disc (DVD) disc drive 1906 coupled to the processor 1901. The server 1900 may also include network access ports 1903 coupled to the multicore processor assemblies 1901 for establishing network interface connections with a network 1905, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various embodiments may be written in a high level programming language such as C, C++, C #, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The present embodiments may be implemented in systems used for medical imaging, Single Photon Emission Computed Tomography (SPECT) for medical applications, and for non-medical imaging applications, such as in baggage security scanning and industrial inspection applications.

While the disclosure has been described in terms of specific embodiments, it is evident in view of the foregoing description that numerous alternatives, modifications and variations will be apparent to those skilled in the art. Each of the embodiments described herein may be implemented individually or in combination with any other embodiment unless expressly stated otherwise or clearly incompatible. Accordingly, the disclosure is intended to encompass all such alternatives, modifications and variations which fall within the scope and spirit of the disclosure and the following claims.

What is claimed is:

1. A method for detecting ionizing radiation using a radiation detector comprised of an array of pixels, comprising:
detecting an amplitude of a primary charge signal in a first pixel of the array of pixels in response to a photon interaction event in the radiation detector;
detecting an amplitude of a secondary charge signal in a second pixel of the array of pixels in response to the photon interaction event, wherein the amplitude of the secondary charge signal is less than the amplitude of the primary charge signal and a polarity of the secondary charge signal is opposite the polarity of the primary charge signal; and
generating a corrected photon energy measurement of the photon interaction event by applying a correction to the detected amplitude of the primary charge signal based on the detected amplitude of the secondary charge signal.

2. The method of claim 1, wherein the second pixel is located laterally or diagonally adjacent to the first pixel in the array of pixels.

3. The method of claim 1, wherein the photon interaction event occurs within the first pixel.

4. The method of claim 1, wherein the primary charge signal and the secondary charge signal are detected using read-out circuitry coupled to each of the pixels of the array of pixels that is configured to measure and distinguish between charge signals having positive and negative polarity in each of the pixels of the array.

5. The method of claim 1, wherein applying the correction comprises subtracting the amplitude of the secondary charge signal from the amplitude of the primary charge signal.

6. The method of claim 5, wherein applying the correction further comprises multiplying the amplitude of the secondary charge signal by a correction factor prior subtracting the amplitude of the secondary charge signal from the amplitude of the primary charge signal.

7. The method of claim 1, wherein the correction that is applied to the detected amplitude of the primary charge signal is based on a function relating the amplitude of the secondary charge signal to charge loss in the primary charge signal due to depth-of-interaction (DOI) effects that is derived using a prior calibration process.

8. The method of claim 1, further comprising detecting at least one additional secondary charge signal having the same polarity as the primary charge signal in one or more neighboring pixels of the first pixel, wherein:
the step of applying the correction comprises subtracting the detected amplitude of the secondary signal having the opposite polarity of the polarity of the primary charge signal from the detected amplitude of the primary charge signal, and adding the detected amplitude of the at least one additional secondary charge signal having the same polarity as the primary charge signal to the amplitude of the primary charge signal.

9. The method of claim 1, wherein secondary charge signals having the polarity that is opposite the polarity of the primary charge signal are detected in multiple neighboring pixels of the first pixel in response to the photon interaction event, and the correction to the detected amplitude of the primary charge signal is based on the detected amplitudes of each of the secondary signals having the opposite polarity of the polarity of the primary charge signal.

10. The method of claim 9, wherein applying the correction comprises subtracting the detected amplitudes each of the secondary signals having the opposite polarity of the polarity of the primary charge signal from the detected amplitude of the primary charge signal.

11. The method of claim 1, further comprising receiving the ionizing radiation at the radiation detector.

12. The method of claim 11, wherein the ionizing radiation comprises gamma radiation having peak photon energies between 140 keV and 450 keV.

13. A method for detecting ionizing radiation using a radiation detector comprised of an array of pixels, comprising:
detecting an amplitude of a primary charge signal in a first pixel of the array of pixels in response to a photon interaction event in the radiation detector;
detecting amplitudes of a plurality of secondary charge signals in a plurality of neighboring pixels of the first pixel, wherein a first set of one or more secondary charge signals has a polarity that is the same as the polarity of the primary charge signal, and a second set of one or more secondary charge signals has a polarity that is opposite the polarity of the primary charge signal; and
generating a corrected photon energy measurement of the photon interaction event by adding the amplitude of each secondary charge signal of the first set of secondary charge signals to the amplitude of the primary charge signal, and subtracting the amplitude of each secondary charge signal of the second set of secondary charge signals from the amplitude of the primary charge signal.

14. The method of claim 13, wherein each of the neighboring pixels are located laterally or diagonally adjacent to the first pixel in the array of pixels.

15. The method of claim 13, wherein the photon interaction event occurs within the first pixel.

16. The method of claim 13, wherein the primary charge signal and the secondary charge signals are detected using read-out circuitry coupled to each of the pixels of the array of pixels that is configured to measure and distinguish between charge signals having positive and negative polarity in each of the pixels of the array.

17. A radiation detector, comprising:
an array of pixels; and
detector processing circuitry coupled to each pixel and configured to detect the amplitude and polarity of charge signals within each pixel, the detector processing circuitry further configured to:
detect an amplitude of a primary charge signal in a first pixel of the array of pixels in response to a photon interaction event in the radiation detector;
detect an amplitude of a secondary charge signal in a second pixel of the array of pixels in response to the photon interaction event, wherein the amplitude of the secondary charge signal is less than the amplitude of the primary charge signal and a polarity of the secondary charge signal is opposite the polarity of the primary charge signal; and
generate a corrected photon energy measurement of the photon interaction event by applying a correction to the detected amplitude of the primary charge signal based on the detected amplitude of the secondary charge signal.

18. The radiation detector of claim 17, wherein the detector processing circuitry is further configured to:
detect at least one additional secondary charge signal having the same polarity as the primary charge signal in one or more neighboring pixels of the first pixel; and
apply the correction by subtracting the detected amplitude of the secondary signal having the opposite polarity of the polarity of the primary charge signal from the detected amplitude of the primary charge signal, and adding the detected amplitude of the at least one additional secondary charge signal having the same polarity as the primary charge signal to the amplitude of the primary charge signal.

19. The radiation detector of claim 17, wherein:
the array of pixels comprises a cadmium zinc telluride substrate having a cathode on a first surface and a plurality of anodes on a second surface; and
the detector processing circuitry comprises a computer or a field programmable gate array coupled to detector read-out circuitry, which comprises an application-specific integrated circuit (ASIC) coupled to the plurality of anodes.

20. A Single Photon Emission Computed Tomography (SPECT) imaging system including the radiation detector according to claim 17.
